(19) United States
(12) Patent Application Publication
(10) Pub. No.: US 2024/0383243 A1
(43) Pub. Date: Nov. 21, 2024

(54) PACKAGING FILM

(71) Applicant: KOROZO AMBALAJ SANAYI VE TICARET A.S., Istanbul (TR)

(72) Inventor: Mustafa ZORLUCA, Istanbul (TR)

(73) Assignee: KOROZO AMBALAJ SANAYI VE TICARET A.S., Istanbul (TR)

(21) Appl. No.: 18/693,172

(22) PCT Filed: Dec. 28, 2022
(86) PCT No.: PCT/TR2022/051652

§ 371 Date: Mar. 19, 2024

(30) Foreign Application Priority Data
Dec. 29, 2021 (TR) 2021/021519

(51) Int. Cl. B32B 27/08; B32B 27/30; B32B 27/32; B65D 65/40

(52) U.S. Cl. CPC B32B 27/08; B32B 27/306; B32B 27/32; B65D 65/40; B32B 2250/05; B32B 2250/246; B32B 2270/00; B32B 2307/414; B32B 2307/54; B32B 2307/581; B32B 2307/7376; B32B 2307/738; B32B 2439/70

(57) ABSTRACT

A thermoformable packaging film is provided for use in the packaging of food products such as meat and meat products, milk and dairy products, seafood, and bakery products, having an inner layer and an outer layer on the other side facing the food product to be placed in the film layers in which it is formed in the event that it becomes a package, and having a barrier layer in the middle. The packaging film includes a compatibilizer layer positioned between the inner layer and the barrier layer, as well as the outer layer and the barrier layer, to connect the other film layers, and the barrier layer is of ethylene vinyl alcohol material with a weight of at most 5% of the total packaging film weight and a thickness of at least 1 micron, with other layers from a polyolefin-based mono material.

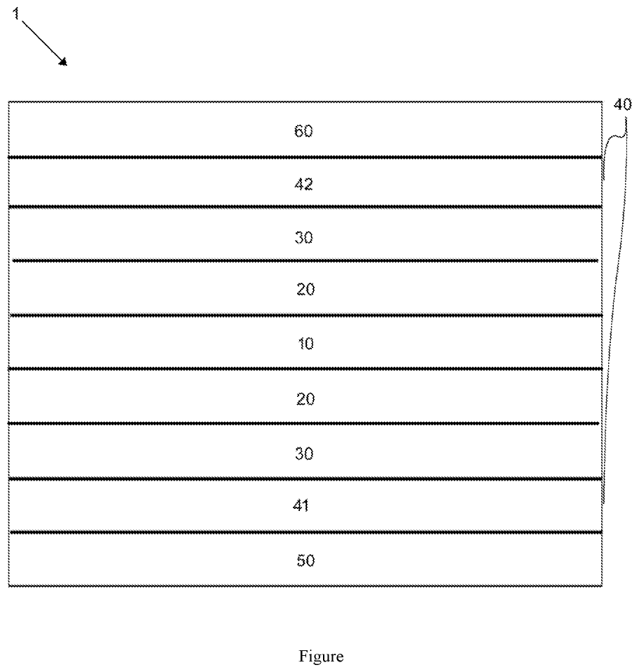

### CROSS REFERENCE TO THE RELATED APPLICATIONS

This application is a national stage entry of International Application No. PCT/TR2022/051652, filed on Dec. 28, 2022, which is based upon and claims foreign priority to Turkey Patent Application No. 2021/021519, filed on Dec. 29, 2021, the entire contents of which are incorporated herein by reference.

### TECHNICAL FIELD

The invention relates to a thermoformable and recyclable packaging film for use in the packaging of food, in particular meat, meat products, milk and dairy products, seafood, and bakery products, as well as non-food products, such as medical products.

### BACKGROUND

Packages are used in the food and non-food sectors, and the packages used especially for food products must be created in a way that will ensure that the products remain intact until the end of their shelf life and have certain visual criteria. Polymers with different properties are used according to the product in the package in order to obtain the properties specified in the packaging films that make up the packages. For example, EVOH as a barrier in a packaging film to be used in food products such as meat and meat products, milk and dairy products, seafood and bakery products, a polyolefin-based compatibilizer that will allow EVOH to adhere to polyolefin, PA, which can provide heat resistance in the outer parts, PP, polyolefin, ionomer, PA, on the source side, raw materials such as EVA, Polyolefin, Plastomer, and ionomer can be used.

In addition to protecting the product and presenting a good visual to the customer, the packaging is now expected to be recyclable. In addition to being recyclable, the need for a packaging film with technical properties that ensure the proper protection of the product in the created packaging has arisen. As a standard, coextruded films made of PA and PE do not undergo the same recycling cycles due to their Tm and Tg, and these films are not considered recyclable.

As a result, all the above-mentioned problems have made it necessary to make an innovation in the related technical field.

### SUMMARY

The present invention relates to a packaging film for eliminating the above-mentioned disadvantages and bringing new advantages to the related technical field.

One object of the invention is to produce a recyclable packaging film with high mechanical strength and heat resistance and suitable for thermoforming.

Another object of the invention is to produce a packaging film with a homogeneous structure suitable for deep drawing, at the same time, with reduced haze.

The present invention is a thermoformable and recyclable packaging film for use in the packaging of food products such as meat and meat products, milk and dairy products, seafood, and bakery products, and having one inner layer facing the food product to be placed inside and one outer layer on the other side and a barrier layer in the middle part of the film layers in which it is formed in case it becomes a package, in order to achieve all the above-mentioned objectives and which will emerge from the detailed explanation below. Accordingly, its novelty is that it includes a compatibilizer layer positioned between the inner layer and the barrier layer, as well as the outer layer and the barrier layer, to connect the other film layers, and the barrier layer is of ethylene vinyl alcohol material with a weight of at most 5% of the total packaging film weight and a thickness of at least 1 micron, with other layers from a polyolefin-based mono material.

In a preferred embodiment of the invention, it includes a functional layer, to provide physical durability.

In a preferred embodiment of the invention, it includes a base layer each, to improve mechanical properties and heat interaction.

In a preferred embodiment of the invention; the compatibilizer layer includes linear low-density polyethylene grafted with maleic anhydride.

In a preferred embodiment of the invention; the compatibilizer layer includes a specific blend of linear low-density polyethylene and polyethylene copolymer grafted with maleic anhydride.

In a preferred embodiment of the invention; the base layers include linear low-density polyethylene 1-hexene copolymer.

In a preferred embodiment of the invention; the base layers include a linear low-density polyethylene 1-hexene copolymer and a low-density polyethylene material.

In a preferred embodiment of the invention; the functional layer includes an inner functional layer facing the inner layer and an outer functional layer facing the outer layer, and the outer functional layer includes a blend of medium-density polyethylene 1-hexene copolymer and low-density polyethylene, and the inner functional layer includes a blend of linear low-density polyethylene 1-hexene copolymer and low-density polyethylene so that the packaging film maintains its physical strength and structural properties when interacting with heat and is easier to shape.

In a preferred embodiment of the invention; the outer functional layer includes a blend of medium-density polyethylene 1-hexene copolymer and low-density polyethylene.

In a preferred embodiment of the invention; the inner functional layer includes a blend of linear low-density polyethylene 1-hexene copolymer and low-density polyethylene.

In a preferred embodiment of the invention; the outer layer includes ethylene 1-hexene copolymer and low-density polyethylene to provide the heat resistance of the packaging film.

In a preferred embodiment of the invention, the inner layer includes 1-octene copolymer plastomer to be welded at low temperature with a top film during the packaging process and linear low-density polyethylene

In a preferred embodiment of the invention, the thickness of the packaging film is between 60 microns and 300 microns.

In a preferred embodiment of the invention, the packaging film is in a structure obtained by the blow extrusion method in a water-cooled extruder.

### BRIEF DESCRIPTION OF THE DRAWINGS

FIGURE shows a schematic view of the packaging film of the invention.

REFERENCE NUMERALS IN THE FIGURES
1 Packaging film
10 Barrier layer
20 Compatibilizer layer
30 Base layer
40 Functional layer
41 Inner functional layer
42 Outer functional layer
50 Inner layer
60 Outer layer

### DETAILED DESCRIPTION OF THE EMBODIMENTS

In this detailed description, the packaging film (1) of the invention is described only by means of examples that will not have any limiting effect for a better understanding of the subject matter.

The packaging film (1) of the invention is a flexible multi-layer film suitable for thermoforming for use in the packaging of food and non-food products such as meat and meat products, milk and dairy products, seafood, and bakery products. The said packaging film (1) is especially used as a sub-film for packaging. The packaging film (1) includes a barrier layer (10) in the middle, and a compatibilizer layer (20) on both sides of the barrier layer (10). Except for the compatibilizer layers (20), there is at least one polyolefin-based film layer. In the preferred embodiment of the invention, there are three polyolefin-based film layers apart from the compatibilizer layers (20), and thus the total packaging film (1) has nine layers. When at least two of the polyolefin-based film layers on each side are combined and treated in this way, the packaging film (1) can have a five-layer or seven-layer configuration. However, the polyolefin content of the packaging film (1) almost does not change.

In more detail, in the case that the packaging film (1) becomes a package, the inward-facing side of the barrier layer (10) is defined as the inner side and the other side as the outer side. According to this; starting from the barrier layer (10), there is a compatibilizer layer (20), a base layer (30), an inner functional layer (41), and an inner layer (50) on the inner side, respectively. On the outer side, there is a compatibilizer layer (20), a base layer (30), an outer functional layer (42), and an outer layer (60) in the continuation of the barrier layer (10) outwards, respectively. The structural properties of the film layers of the packaging film (1) are described below.

Ethylene vinyl alcohol (EVOH) material is used in the barrier layers (10) of the packaging film (1). The EVOH material may have different contents. The ratio of the EVOH material to the total material used for the total packaging film (1) is provided at a maximum of 5% by weight. The barrier layer (10) has a thickness that will provide adequate barrier properties. This thickness is provided so that the weight of the EVOH material does not exceed 5% by the weight of the total packaging film (1). In another embodiment, this thickness is provided so that the weight of the EVOH material does not exceed 3 wt % of the total packaging film (1). The packaging film (1) thus obtained complies with the regulations for recyclable packaging made of mono material.

The compatibilizer layers (20) connect the EVOH and polyolefin-based film layers within the packaging film (1). Since EVOH includes a polar group and polyolefins are nonpolar, the compatibilizer layers (20) are included in the packaging film (1), thus overcoming the difficulty of co-extruding polar groups and nonpolar chains. Compatibilizer layers (20) are provided at minimum thickness. In a preferred embodiment, the compatibilizer layer (20) consists of linear low-density polyethylene grafted with maleic anhydride alone. In an alternative embodiment, the compatibilizer layer (20) is formed from a specific blend of linear low-density polyethylene grafted with maleic anhydride and a polyolefin-based polymer.

The base layers (30) meet the requested mechanical properties and heat interaction of the packaging film (1). Accordingly, the opposing base layers (30) include a linear low-density polyethylene 1-hexene copolymer symmetrically, since they are exposed to heat with almost the same effect. Alternatively, PE and PE copolymers can be used as base layers (30). In one embodiment, the base layers (30) are formed from a specific blend of linear low-density polyethylene 1-hexene copolymer and low-density polyethylene. Again, in these layers, structures with relatively higher density and homogeneous free ends are preferred. Thereby, the heat dissipation between the layers of the packaging film (1) becomes more efficient.

Due to the structural properties of the functional layers (40), the physical durability of the packaging film (1) and the preservation of its structural properties when interacting with heat are ensured. In addition, forming of the packaging film (1) is facilitated by the structural feature of the functional layer (40). Since the heat source contacts the packaging film (1) from the outer layer (60) during the packaging process, the outer layer (60) of the packaging film (1) interacts the most with the heat. Therefore, the interaction with the heat in the outer functional layer (42) is higher than the inner functional layer (41) and the material content of the inner functional layer and the outer functional layer (42) varies. Since high-density and straight-chain films interact with heat harder, a mixture of medium-density polyethylene 1-hexene copolymer and low-density polyethylene is used in the outer functional layer (42) by using this advantage of the polymer. The inner functional layer (41) includes a linear low-density polyethylene 1-hexene copolymer and a low-density polyethylene mixture.

The inner layer (50) is the layer that is welded with a top film during packaging, in other words, the structures of the polymer chains are broken down and combined with the help of heat. Therefore, the inner layer (50) is provided in a structure that can be easily affected by heat, weld at low temperatures, and form strong chains after welding. Accordingly, the inner layer (50) includes a 1-octene copolymer plastomer. In one embodiment, the inner layer (50) includes a mixture of 1-octene copolymer plastomer and linear low-density PE. In alternative embodiments, other polyethylene copolymers and plastomers can be used in the inner layer (50), and low-density, straight-chain structures are preferred.

The outer layer (60) includes ethylene 1-hexene copolymer and low-density polyethylene and provides high heat resistance.

The inner layer (50), outer layer (60), and compatibilizer layers (20) in the packaging film (1) consist of polyethylene-based materials in the preferred embodiment as mentioned above. As polyolefin, any polymerized or copolymerized olefin can be used instead of polyethylene. The said olefins can be butene or octene olefin copolymers, ethylene-propylene copolymers, and butene octene terpolymers. These olefins can be supplied in linear, branched, cyclo, substituted, unsubstituted or modified forms.

The packaging film (1) is considered recyclable since the ratio of EVOH in the total packaging film (1) by weight does not exceed 5% and the other material that makes up the packaging film (1) apart from EVOH is polyolefin of the same type.

The total thickness of the packaging film (1) is between 50 microns and 300 microns. With the increase in thickness, the amount of deep drawing, mechanical strength, and hardness of the film increase. In addition, thicker packaging films (1) are preferred for packages that are more difficult to pack, in other words, with hard and sharp corners.

The packaging film (1) is produced by the blowing extrusion method in a water-cooled extruder. The production method mentioned is carried out using cold water at about 10° C. In this production method, since the packaging film (1) coming out of the extruder head cools rapidly, more amorphous regions are formed on it compared to other methods, and the packaging film (1) has a transparent appearance. In addition, the flexibility of the packaging film (1) increases, and it becomes easier to form.

Packaging film (1) with the structural details given above has low haze, high heat resistance, high puncture resistance, and high breaking strength and can work in forming machines in wide temperature ranges. The packaging film (1) can take form in forming machines at forming temperatures between 90-130 C and forming times between 0.5-3 seconds. The haze value of the packaging film (1) before forming can be between 5-20% depending on the thickness and structure.

The following are the comparative test results for various thicknesses of the packaging film including polyamide and polyethylene, and the packaging film (1) of the invention. The puncture resistance test was performed as per ASTM F 1306 standard; the haze was measured as per ASTM D1003 standard, and the modulus of elasticity was measured as per ASTM D882 standard.

MD denotes the machine direction and CD donates the machine width direction horizontally to the MD direction by 90 degrees.

TABLE 1
Comparative test results of PA-PE structure and packaging film of the invention

| | | | | Elasticity | Elasticity |
|---|---|---|---|---|---|
| | | | Puncture | modulus | modulus |
| | Thickness | | resistance | (N/mm\hat{ }2) | (N/mm\hat{ }2) |
| Structure | (μ) | Haze (%) | (N) | (MD) | (CD) |
| PA-PE structure | 100 | ~5-~9 | 23-30 | ~430 | ~430 |
| Packaging film | 100 | ~8-~10 | 20-27 | ~350 | ~350 |
| (1) of the | | | | | |
| invention | | | | | |
| PA-PE structure | 130 | ~6-~10 | 25-35 | ~410 | ~400 |
| Packaging film | 130 | ~8.5-~11 | 23-30 | ~340 | ~340 |
| (1) of the | | | | | |
| invention | | | | | |
| PA-PE structure | 150 | ~6-~12 | 27-37 | ~400 | ~390 |

film

| | | | | | |
|---|---|---|---|---|---|
| Packaging film | 150 | ~10-~12 | 25-30 | ~330 | ~330 |
| (1) of the | | | | | |
| invention | | | | | |
| PA-PE structure | 200 | ~7-~15 | 35-45 | ~400 | ~390 |
| Packaging film | 200 | ~11-~15 | 28-35 | ~290 | ~300 |
| (1) of the | | | | | |
| invention | | | | | |
| PA-PE structure | 250 | ~8-~16 | 45-55 | ~400 | ~390 |
| Packaging film | 250 | ~12-~16 | 33-40 | ~275 | ~280 |
| (1) of the | | | | | |
| invention | | | | | |

According to the test results given in Table 1, although polyamide (PA) is not used in the packaging film (1), the details of which are explained above, it is seen that the values do not deviate significantly and are preserved. When examined in detail, it is observed that haze does not increase; the puncture resistance and elasticity modules do not decrease significantly and still have close values. This shows that while the packaging film (1) of the invention is suitable for recycling, it also meets the requested results and the values do not change at an unacceptable rate.

The protection scope of the invention is given in the attached claims and cannot be strictly limited to what has been described in this detailed description for illustrative purposes. It is clear that those skilled in the art can put forth similar embodiments in the light of what has been described above, without departing from the main theme of the invention.

1. A thermoformable packaging film for use in the packaging of food products such as meat and meat products, milk and dairy products, seafood and bakery products, having an inner layer facing the food product to be placed inside and an outer layer on the other side and a barrier layer in a middle part of film layers in which it is formed in case it becomes a package, comprising:
compatibilizer layers, each positioned between the inner layer and the barrier layer, as well as the outer layer and the barrier layer, to connect the other film layers, and the barrier layer is of ethylene vinyl alcohol material with a weight of at most 5% of the total packaging film weight and a thickness of at least 1 micron, with other layers from a polyolefin-based mono material.

2. The thermoformable packaging film according to claim 1, further comprising a functional layer, to provide physical durability.

3. The thermoformable packaging film according to claim 1, further comprising a base layer, to improve mechanical properties and heat interaction.

4. The thermoformable packaging film according to claim 1, wherein each of the compatibilizer layers comprises linear low-density polyethylene grafted with maleic anhydride.

5. The thermoformable packaging film according to claim 1, wherein each of the compatibilizer layers comprises a blend of linear low-density polyethylene and polyethylene copolymer grafted with maleic anhydride.

6. The thermoformable packaging film according to claim 3, wherein the base layers comprises linear low-density polyethylene 1-hexene copolymer.

7. The thermoformable packaging film according to claim 3, wherein the base layers comprises a blend of linear low-density polyethylene 1-hexene copolymer and low-density polyethylene.

8. The thermoformable packaging film according to claim 2, wherein the functional layer comprises an inner functional layer facing the inner layer and an outer functional layer facing the outer layer, and the outer functional layer comprising a medium density polyethylene 1-hexene copolymer such that a physical strength and structural properties of the thermoformable packaging film when interacting with heat are preserved and easy to form, and the inner functional layer comprising a linear low-density polyethylene 1-hexene copolymer.

9. The thermoformable packaging film according to claim 8, wherein the outer functional layer comprises a blend of medium-density polyethylene 1-hexene copolymer and low-density polyethylene.

10. The thermoformable packaging film according to claim 8, wherein the inner functional layer comprises a blend of linear low-density polyethylene 1-hexene copolymer and low-density polyethylene.

11. The thermoformable packaging film according to claim 1, wherein the outer layer comprises ethylene 1-hexene copolymer and low-density polyethylene to provide a heat resistance of the thermoformable packaging film.

12. The thermoformable packaging film according to claim 1, wherein the inner layer comprises 1-octene copolymer plastomer to be welded at low temperature with a top film during a packaging process and linear low-density polyethylene.

13. The thermoformable packaging film according to claim 1, wherein the thermoformable packaging film has a thickness between 60 microns and 300 microns.

14. The thermoformable packaging film according to claim 1, wherein the thermoformable packaging film has a structure obtained by a blow extrusion method in a water-cooled extruder.
